(19) United States
(12) Patent Application Publication
(10) Pub. No.: US 2004/0134727 A1
(43) Pub. Date: Jul. 15, 2004

(54) Brake shoe for braking a cable

(76) Inventor: Walter Windlin, Alpnach Dorf (CH)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/744,165

(22) Filed: Dec. 22, 2003

(30) Foreign Application Priority Data
Dec. 24, 2002 (EP) 02406146.7

(51) Int. Cl. F16D 69/00

(52) U.S. Cl. 188/250 R

(57) ABSTRACT

A brake shoe for braking a cable such as during speed limitation of an elevator. The brake shoe includes a shoe body supporting a brake lining facing the cable to be braked. The brake lining has at least two lining regions formed of different materials providing different effective braking properties during simultaneous contact with the cable.

### BACKGROUND OF THE INVENTION

The present invention relates to a brake shoe for a brake, which brake acts on a cable of an elevator or other cable-drive conveying apparatus with a brake lining.

Brake shoes of the kind used particularly in equipment for the limitation of the speed of elevator cars of high-performance elevators are known. In that case there is used as an auxiliary cable a closed cable, namely a so-termed speed limiter cable, which is simply termed cable in the following. This cable runs around a cable roller of a speed limiter mounted at the top in an elevator shaft and around a tensioning roller mounted at the bottom in the elevator shaft and it is connected with the elevator car by way of a safety brake device trigger lever. If the speed of the elevator car exceeds a certain limit speed, for example approximately 10 meters per second, then the speed limiter cable is blocked by the speed limiter, whereby the braked cable actuates the safety brake device trigger lever moving with the travelling elevator car and thus triggers the safety brake device mounted in the car.

Devices for braking or blocking cables by brake shoes, which comprise a brake shoe body and a continuous brake lining fastened thereto, with an effective surface which during braking is brought into contact with the cable, are known.

Brake shoes are shown in the U.S. Pat. No. 6,371,261 B1, which shoes substantially consist of a brake shoe body and of covers or linings with effective surfaces facing the cable to be braked, wherein several spaced-apart first lining regions are present, between which second lining regions of a different material are arranged; the second lining regions projecting beyond the first lining regions in such a manner that during braking only the second lining regions facing the cable contact the cable; only the second lining regions in that case form effective operative surfaces or brake surfaces, this being because they would be worn to such an extent that they would lie flush with the first lining regions.

It is disadvantageous with the previously known devices of this kind or with the previously used brake shoes that on initiation of braking for the purpose of speed limitation the cable is braked in a manner which in practice is juddery. On the one hand this is very unpleasant for passengers of an elevator car and on the other hand has the consequence of transient high mechanical material loads that lead to high material wear.

### SUMMARY OF THE INVENTION

The present invention concerns a brake shoe so constructed that the brake lining thereof facing the cable consists of at least two lining regions which are formed by different materials and which are arranged adjacent to one another and so designed that during braking, i.e. when the brake shoe is disposed in its operative position, the surface regions of these lining regions together bear against the cable. In that case not only the first lining regions, i.e. the regions of the first material, but also the second lining regions, i.e. the regions of the second material, form effective operative surfaces or braking surfaces.

With the brake shoe according to the present invention it is possible to simultaneously utilize the different effective properties, which are positive with respect to a desired form of braking, of the two materials. Although in the case of use of the brake shoe according to the present invention when the braking travel is generally prolonged, it is possible to not only ensure a reliable braking or a desired or prescribed speed limitation, but also to prevent a juddery, material-wearing braking. Overall, a synergy results between surface regions of the first material, which alone would intrinsically cause a juddery braking, but is durable, and surface regions of the second material, which would alone intrinsically cause a more gentle, in a given case too-gentle, braking action, but is very susceptible to wear.

Performance of the braking can be optimized by appropriate dimensioning and arrangement of the lining regions of the effective surface formed by the different materials.

Moreover, through appropriate shaping of the lining regions, in a given case with gaps, it can be achieved that abrasion particles arising during braking due to friction between the cable and the effective surface of the brake lining are so deflected that they do not have a disruptive effect.

As already mentioned, the lining regions, which face the cable, or the surface regions, which bound them, of the brake shoe bear under pressure against the cable, which is to be braked, when the brake shoe is disposed in its operative position. The braking surfaces of all different lining regions then lie at least approximately in surfaces which are continuous in the direction of the cable and which are substantially complementary to the external surface of the cable, so that the cable is at least partly surrounded by the braking surfaces during braking. Preferably the first and the second and optionally further materials, from which the brake lining is produced, are so selected that the braking surface forms a continuous surface—optionally with small gaps—substantially complementary to the outer surface of the cable even when the brake shoe does not adopt its operative position. This means that the brake lining does not have any projecting regions even when the brake shoe is not disposed in the operative position thereof. Such projecting regions could be produced from, for example, readily compressible or otherwise readily deformable material so that the brake lining would receive a form complementary to the cable only on contact with the cable.

The brake shoe according to the present invention is generally so constructed that it comprises a brake shoe body which has at least two lining regions of the brake lining.

In a preferred construction of the brake shoe, the brake shoe body itself is made of one of the two materials. The brake shoe body can, however, also be made of another suitable material in the form of a block or a carrier structure.

In general, the brake shoe according to the present invention is constructed so that the lining regions of one of the materials are indeed connected together, but have, at the side facing the cable, recesses in which the lining regions of the other one of the materials are received.

The lining regions of the different materials can be arranged one after the other in the direction of the relative movement between cable and brake shoe and/or arranged transversely to this direction or in any desired configuration, for example in the manner of a fishbone pattern.

Respectively adjacent lining regions of different materials can either directly adjoin one another or be separated from one another by gaps.

In a preferred embodiment of the brake shoe a metallic material is selected as the first material, wherein, for example, bronze, particularly aluminum-bronze, has proved very satisfactory.

The first material can also be a hard rubber-like or synthetic material or a plastic material, which preferably has a fiber reinforcement.

It has proved particularly advantageous to select a sintered material at least for the second material.

In a development of the brake shoe, the brake lining intended for contact with the cable can have at least one lining region of a further suitable material.

An object of the present invention is providing an improved brake shoe which on the one hand is wear-resistant and on the other hand avoids a juddery braking.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1A is a transverse cross-sectional view of two brake shoes according to the present invention, in a non-actuated position, with a cable to be braked;

FIG. 1B is a view similar to FIG. 1A showing the brake shoes in an actuated or operative position;

FIG. 2A is a longitudinal cross-sectional view of a brake shoe according a first embodiment of the present invention;

FIG. 2B is a longitudinal cross-sectional view of a brake shoe according a second embodiment of the present invention;

FIG. 2C is a longitudinal cross-sectional view of a brake shoe according a third embodiment of the present invention;

FIG. 3A is a front elevation view of a brake shoe according to a fourth embodiment of the present invention;

FIG. 3B is a front elevation view of a brake shoe according to a fifth embodiment of the present invention;

FIG. 3C is a front elevation view of a brake shoe according to a sixth embodiment of the present invention;

FIG. 4 is a plan view of a speed limiter with a cable roller and a brake device for a cable to be braked, in a position in which the cable is not braked, for use with the brake shoes according to the present invention.

### DESCRIPTION OF THE PREFERRED EMBODIMENT

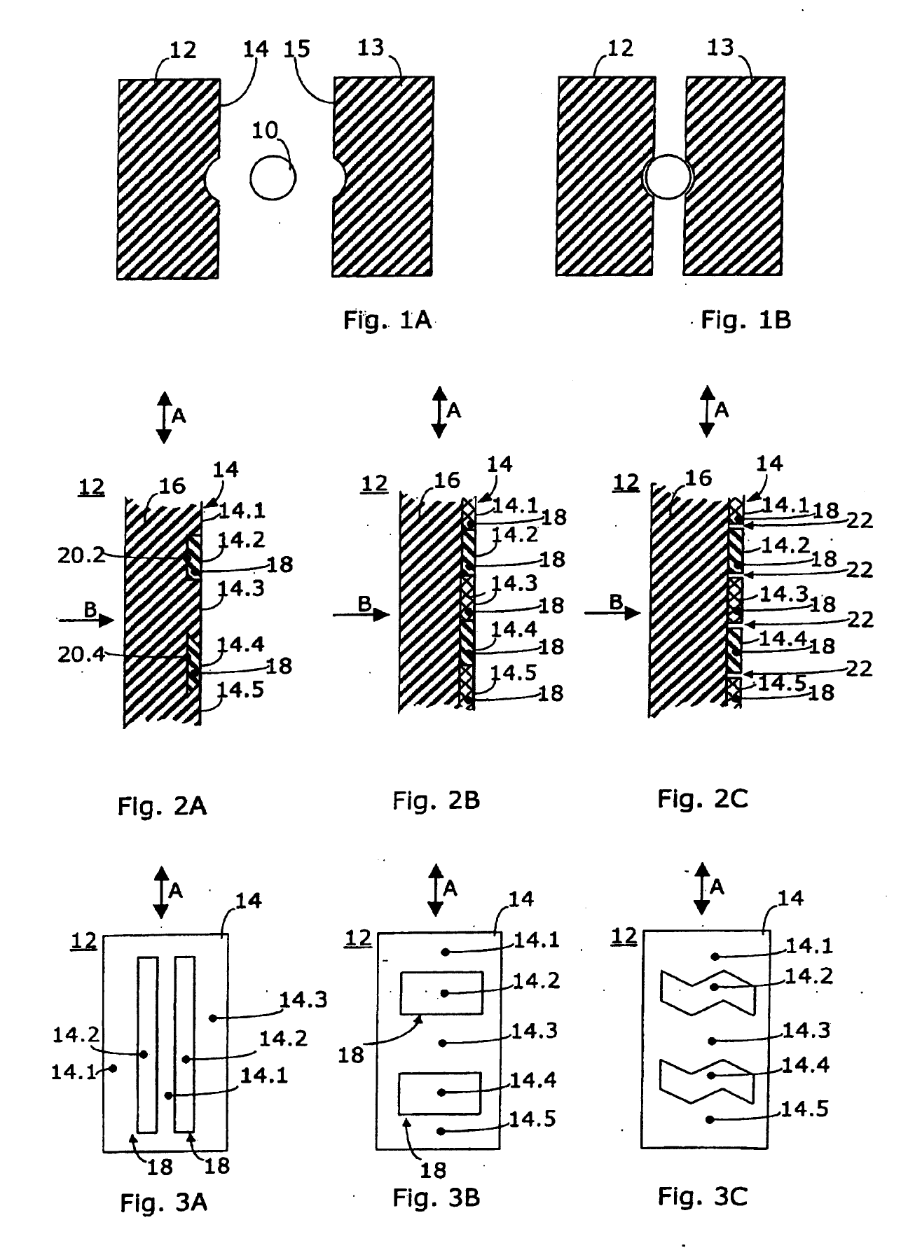

FIGS. 1A and 1B show a cable 10 and a brake shoe pair with two brake shoes 12, 13, which are provided for braking or blocking the cable 10. The movement of the cable 10 relative to the brake shoes 12, 13 is in this case perpendicular to the plane of the drawing. The brake shoes 12, 13 are constructed and arranged to be mirror-symmetrical in the illustrated form of embodiment. It may be noted that the number of two brake shoes and the illustrated arrangement and shaping are usual, but are not obligatory.

Each of the brake shoes 12, 13 comprises a brake lining 14 or 15 respectively with an overall effective surface, and which is formed to be at least approximately complementary to the outer surface of the cable 10. In the illustration according to FIG. 1A the cable 10 is not braked, the brake shoes 12 and 13 do not adopt their operative position and the effective surfaces, which are intended for contact with the cable 10, of the brake linings 14 and 15 of the brake shoes 12 and 13 here do not contact the outer surface of the cable 10. In the illustration according to FIG. 1B the cable 10 is braked, the brake shoes 12, 13 bearing under pressure against the cable 10 so that the overall effective surfaces, which are intended for contact with the cable 10, of the brake linings 14 and 15 contact the cable 10.

In FIG. 2A there is illustrated a first embodiment single brake shoe 12a which is displaceable in the direction of an arrow B for performance of braking, whilst the direction of the relative movement between the cable 10 and the brake shoe 12a is indicated by a double arrow A.

The brake shoe 12a illustrated in FIG. 2A comprises a brake shoe body 16a with a brake lining 14a, which is bounded by the overall effective surface intended for contact with the cable 10. The brake lining 14a has several lining regions of different materials. In the part, which is illustrated in FIG. 2A, of the brake shoe 12a, there are visible—of the brake lining 14a—five mutually adjacent lining regions 14.1 to 14.5. The lining regions 14.1, 14.3, 14.5 are formed by a first material, namely the material of the brake shoe body 16a itself. The lining regions 14.2, 14.4 are formed by a different material; they are outer surfaces of insert parts 18a and 18b fastened in recesses 20.2 and 20.4 respectively of the brake shoe body 16a, wherein the recesses 20.2 and 20.4 extend from the effective surface bounding the brake lining 14a into the brake shoe body 16a.

The effective properties—which are positive for the intended form of braking or blocking of a speed limiter cable—of the two materials are different. Through co-operation thereof on contact with the cable 10 the specific effective braking properties of the two materials can be utilized at the same time. The kind and course of the braking can be influenced by a suitable dimensioning of the overall brake lining 14a and the individual lining regions 14.1 to 14.5. The dimensions of the individual lining regions can be the same or different. In a preferred embodiment of the brake shoe a metallic material is selected as the first material, wherein, for example, bronze, particularly aluminum-bronze, has proved very satisfactory. The first material can also be a hard rubber-like or synthetic material or a plastic material, which preferably has a fiber reinforcement. It has proved particularly advantageous to select a sintered material at least for the second material, for example graphite-bronze.

The fastening of the insert parts 18a and 18b in the brake shoe body 16a can be effected in any desired manner, in particular in a force-locking manner or a shape-locking manner; adhesives and mechanical connecting elements, such as screws or rivets, may be mentioned as examples for possible connections. There can also be used, for example, a dovetail-like profile construction as illustrated in FIG. 2A for the lower recess 20.4 and the insert part 18b received therein. A press-fit or shrink-fit is also suitable.

FIG. 2B shows a second embodiment individual brake shoe 12b with a brake shoe body 16b. All lining regions 14.1 to 14.5 of a brake lining 14b are here formed by outer surfaces of insert parts 18c and 18d fastened to the brake shoe body 16b. In that case, the lining regions 14.1, 14.3, 14.5 are formed by the insert parts 18c of a first material and the lining regions 14.2, 14.4 by the insert parts 18d of a second material.

A further third embodiment brake shoe 12c is illustrated in FIG. 2C as being of similar construction to the brake shoe 12b of FIG. 2B. Whilst in the case of the brake shoes of FIGS. 2A and 2B the respective adjacent lining regions directly adjoin one another, according to FIG. 2C adjacent lining regions 14.1 and 14.2, 14.2 and 14.3, 14.3 and 14.4, 14.4 and 14.5 are separated from one another by gaps 22.

FIGS. 3A to 3C show, by way of example, three further variants of the subdivision of the braking surface 14 into the lining regions 14.1, 14.3, 14.5 formed by a first material and the lining regions 14.2, 14.4 formed by a second material.

A fourth embodiment brake shoe 12d with a lining 14d according to FIG. 3A exhibits the two lining regions 14.2, 14.2, which are formed by insert parts 18e, in the form of strips extending parallel to the direction of the relative movement of cable 10 and brake shoe 12d, i.e. in the direction of the arrow A. In this arrangement the respective length section, which is disposed between the brake shoes, of the cable is virtually continuous, but in contact with the second material of the brake lining 14d only by parts of its circumference.

A fifth embodiment brake shoe 12e with a lining 14e according to FIG. 3B exhibits the two lining regions 14.2, 14.4, which are formed by insert parts 18f, in the form of strips extending perpendicularly to the direction of the relative movement of cable 10 and brake shoe 12e. In this arrangement the respective length section, which is disposed between the brake shoes, of the cable comes into contact with the first material and the second material of the brake lining 14e in alternation in time, but by its entire circumference or by a substantial part of its circumference. The lining regions can also be arranged in an inclined position, for example at an angle of 45°, relative to the relative movement direction arrow A.

In FIG. 3C there is illustrated a sixth embodiment brake shoe 12f in which the lining regions 14.2, 14.4 are arranged in a fishbone-like (herringbone) configuration insert part 18g of a brake lining 14f.

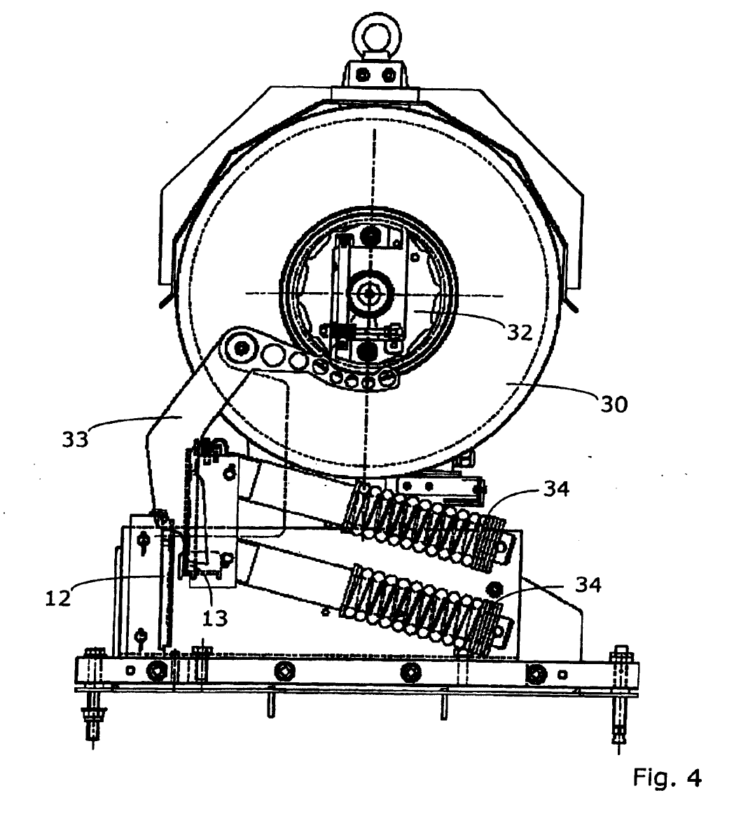

FIG. 4 shows details of a device for braking or blocking of the cable 10, which is not illustrated, by brake shoes 12, 13 according to the present invention.

In FIG. 4, an elevator speed limiter with a cable roller 30 for a speed limiter cable is illustrated. The cable roller 30 has two centrifugal weights 32 which co-operate with a lever 33. Of the two brake shoes 12, 13 intended for braking the cable the brake shoe 12 is fixed and the brake shoe 13 is so guided by way of a parallelogram linkage with springs 34 that in the raised position it is spaced from the cable (not illustrated) and from the shoe 12. In this raised position it is held by a lug which is formed at a first, in this case vertical, arm of the lever 33. This setting is adopted when the speed of the speed limiter cable lies below a specific limit speed. In the case of excess speed, i.e. when the speed of the speed limiter cable exceeds the limit speed, the two centrifugal weights 32 move radially outwardly from the center axis of the cable roller 30 and in that case impinge on the second arm, which is provided with recesses, of the lever 33. The lever 33 thereby rotates—in clockwise sense in FIG. 4—whereby the lug moves to the left and the brake shoe 13, which is now no longer supported by it, can drop. Due to the action of the inclined parallelogram linkage with the springs 34 the brake shoe 13 is guided towards the cable and the other brake shoe 12 and entrained by the cable downwardly onto an abutment. The horizontal component of the movement has the consequence that the cable is clamped between the two brake shoes 12, 13, wherein the clamping force is limited by the springs 34 of the parallelogram linkage.

The brake shoe according to the present invention is particularly, but not exclusively, suitable for use in cable brakes of elevators, for example for braking a speed limiter cable or for braking the support cables of elevator car and counterweight. However, it can also find use in other cable-driven conveying means, for example cableways.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A brake shoe for a brake acting on a cable of a cable-drive conveying means, the brake shoe having a brake lining which faces the cable to be braked and, in operation bears against the cable, comprising:
a brake shoe body; and
a brake lining having at least a first lining region formed of a first material and a second lining region formed of a second material, said first and second materials having different braking properties, said brake lining being shaped for simultaneous contact between the cable and said first and second lining regions in an operative position of the brake shoe during braking of the cable.

2. The brake shoe according to claim 1 wherein an overall effective surface of said brake lining is at least approximately continuous and is complementary to an outer surface of the cable when the brake shoe is not in the operative position.

3. The brake shoe according to claim 1 wherein said brake shoe body forms said first lining region.

4. The brake shoe according to claim 1 wherein said brake lining has at least two of said first lining region and at least two of said second lining region.

5. The brake shoe according to claim 1 wherein said brake shoe body has a recess formed therein and said second lining region is received in said recess.

6. The brake shoe according to claim 5 wherein said recess and said second lining region have a dovetail profile.

7. The brake shoe according to claim 1 wherein said first and second lining regions are directly adjacent to one another.

8. The brake shoe according to claim 1 wherein said first and second lining regions are separated by a gap.

9. The brake shoe according to claim 1 wherein said first and second lining regions extend longitudinally in a direction of relative movement between the cable and the brake shoe.

10. The brake shoe according to claim 1 wherein said first and second lining regions extend longitudinally transverse to a direction of relative movement between the cable and the brake shoe.

11. The brake shoe according to claim 1 wherein said second lining region has a herringbone shape.

12. The brake shoe according to claim 1 wherein said first material is a metallic material.

13. The brake shoe according to claim 12 wherein said first material is one of bronze and aluminum-bronze.

14. The brake shoe according to claim 1 wherein said first material is a fiber reinforced plastic material.

15. The brake shoe according to claim 1 wherein said second material is a sintered graphite-bronze material.

16. A brake shoe for a brake acting on a cable of a cable-drive conveying means, the brake shoe having a brake lining which faces the cable to be braked and, in operation bears against the cable, comprising:
a brake lining having at least a first lining region formed of a first material and a second lining region formed of a second material, said first and second materials having different braking properties; and
a brake shoe body supporting said brake lining and being formed of a third material, said brake lining being shaped for simultaneous contact between the cable and said first and second lining regions in an operative position of the brake shoe during braking of the cable.

17. The brake shoe according to claim 16 wherein said first and second lining regions are directly adjacent to one another.

18. The brake shoe according to claim 16 wherein said first and second lining regions are separated by a gap.

19. An elevator speed limiter having a pair of opposed brake shoes for acting on an elevator cable comprising:
a pair of spaced apart brake shoe bodies;
a mechanism attached to the brake shoe bodies for moving the brake shoe bodies toward one another in response to an overspeed condition of an elevator car supported by a cable; and
a brake lining attached to each of said brake shoe bodies, each said brake lining having at least a first lining region formed of a first material and a second lining region formed of a second material, said first and second materials having different braking properties, said brake linings being shaped for simultaneous contact between the cable and said first and second lining regions in an operative position of the brake shoes during braking of the cable.
